(19) United States
(12) Patent Application Publication
(10) Pub. No.: US 2024/0227682 A9
(43) Pub. Date: Jul. 11, 2024

(54) CARGO-MODULE ARRANGEMENT FOR A VEHICLE

(71) Applicant: LEAR CORPORATION, Southfield, MI (US)

(72) Inventors: Sumanth MUTHYALA, Ann Arbor, MI (US); Lea Thomas SMITH, Severna Park, MD (US); Aaron ROGGOW, Rochester Hills, MI (US); Salim MAROUF, Detroit, MI (US); Arjun YETUKURI, Rochester Hills, MI (US)

(73) Assignee: LEAR CORPORATION, Southfield, MI (US)

(21) Appl. No.: 17/972,271

(22) Filed: Oct. 24, 2022

(51) Int. Cl. B60R 5/04

(52) U.S. Cl. CPC B60R 5/04

(57) ABSTRACT

A cargo-module arrangement for a vehicle having a body-in-white (BIW) portion and a load floor secured to the BIW portion may include a cargo platform disposed above the load floor and having a front edge and a back edge. The cargo platform may be selectively movable along a track arrangement in forward and rearward directions and include a cargo gate disposed proximate to the back edge. The cargo gate may include a forward edge and a rearward edge and may be pivotable upward about at least one of the forward edge or the rearward edge.

### TECHNICAL FIELD

The present disclosure relates to a cargo-module arrangement for a vehicle.

### BRIEF DESCRIPTION OF THE DRAWINGS

FIG. 1 shows a cargo-module arrangement positioned on a storage well in the back of a vehicle in accordance with embodiments described herein;

FIG. 2 shows the cargo-module arrangement of FIG. 1 positioned rearward for easy access of cargo from behind the vehicle;

FIG. 3 shows a cargo-module arrangement for a vehicle in accordance with embodiments described herein;

FIGS. 4A and 4B show features of the cargo-module arrangement shown in FIG. 3;

FIG. 5 shows a detail of a cargo gate from the cargo-module arrangement shown in FIG. 3;

FIG. 6 shows a cargo-module arrangement for a vehicle in accordance with embodiments described herein;

FIG. 7 shows features of the cargo-module arrangement shown in FIG. 6;

FIG. 8 shows a cargo-module arrangement for a vehicle in accordance with embodiments described herein;

FIG. 9 shows features of the cargo-module arrangement shown in FIG. 8; and

FIG. 10 shows a tilting feature of a cargo-module arrangement accordance with embodiments described herein.

### DETAILED DESCRIPTION

Reference will now be made in detail to embodiments, examples of which are illustrated in the accompanying drawings. In the following detailed description, numerous specific details are set forth to provide a thorough understanding of the various described embodiments. It will be apparent to one of ordinary skill in the art, however, that the various described embodiments may be practiced without these specific details. In other instances, well-known methods, procedures, components, circuits, and networks have not been described in detail so as not to unnecessarily obscure aspects of the embodiments.

It is to be understood that the disclosed embodiments are merely exemplary and that various and alternative forms are possible. The figures are not necessarily to scale: some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” includes a function being performed by one element, a function being performed by more than one element—e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various embodiments herein is for the purpose of describing particular embodiments only and is not intended to be limiting. As used in the description of the various embodiments and the appended claims, the singular forms “a”, “an” and “the” are intended to include the plural forms as well, unless the context clearly indicates otherwise. It will be further understood that the terms “includes,” “including,” “comprises,” or “comprising,” when used in this specification, specify the presence of stated features, integers, steps, operations, elements, or components, but do not preclude the presence or addition of one or more other features, integers, steps, operations, elements, components, or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

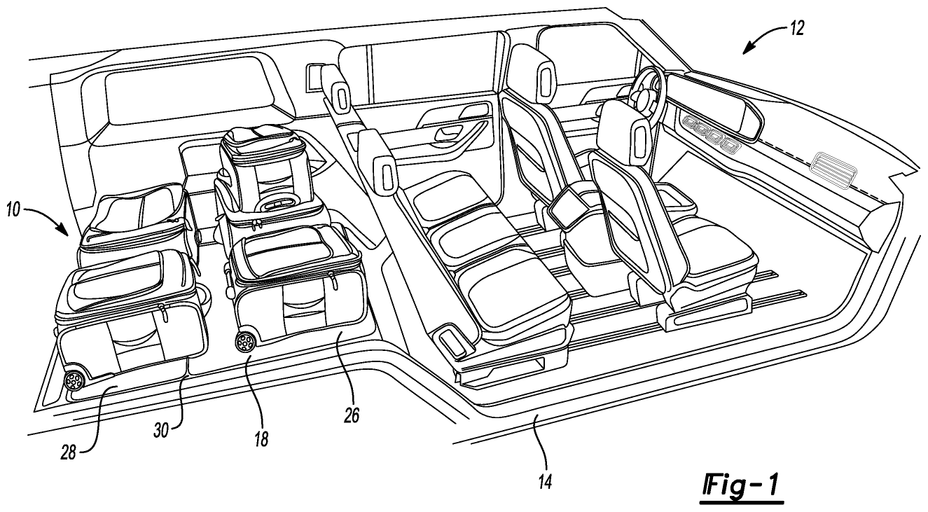

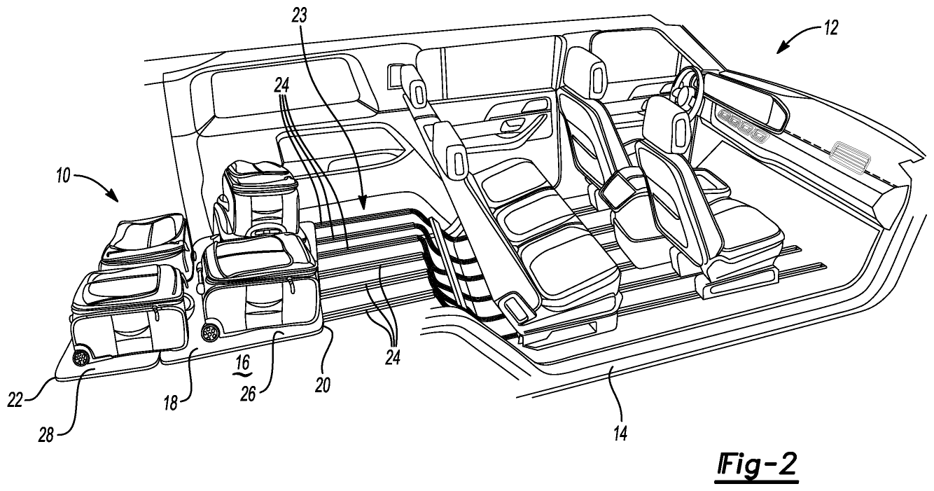

FIGS. 1 and 2 show a cargo-module arrangement 10 for a vehicle 12 in accordance with embodiments described herein. The vehicle 12 includes a body-in-white (BIW) portion 14, which is, for example, a vehicle support structure and may include a vehicle frame, floor, etc. The vehicle 12 also includes a load floor 16 secured to the BIW portion 14. The cargo-module arrangement 10 includes a cargo platform 18 disposed above the load floor 16. It includes a front edge 20, and a back edge 22, as shown in FIG. 2. The cargo platform 18 is selectively movable along a track arrangement 23 in forward and rearward directions relative to the vehicle 12. The track arrangement 23 includes a plurality of tracks 24 attached to the BIW portion 14 and oriented in a longitudinal vehicle direction—i.e., front-to-back and back-to-front. In the embodiment shown in FIGS. 1 and 2, the cargo platform 18 is divided into a front portion 26 and a rear portion 28, which are joined together at a hinged connection 30. This allows at least the rear portion 28—and at least the back edge 22—to pivot downward below the load floor 16 when the cargo platform 18 or rear portion 28 is positioned at its farthest point rearward and the rear portion 28 is outside of the vehicle 12.

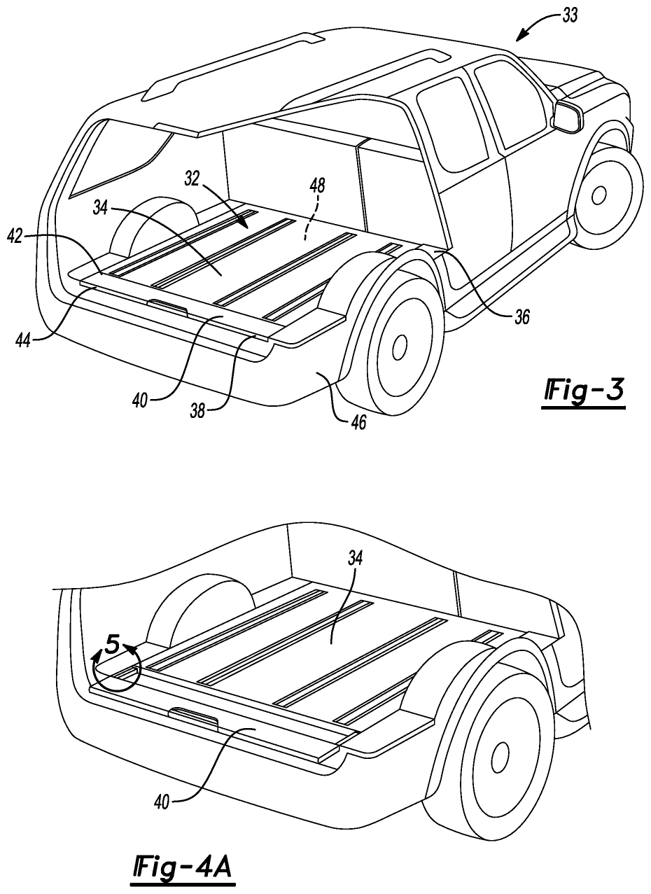

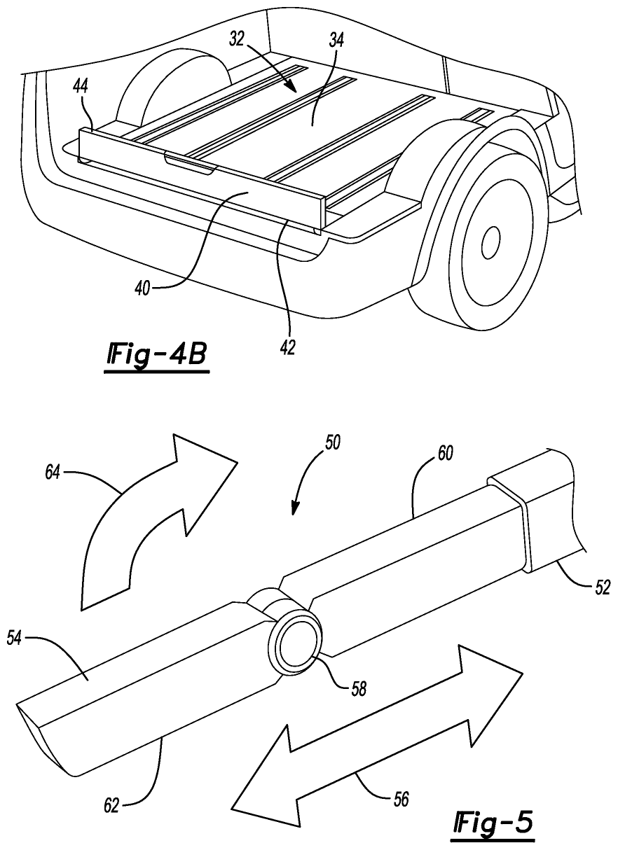

FIG. 3 shows a cargo-module arrangement 32 for a vehicle 33 in accordance with embodiments described herein. The cargo-module arrangement 32 includes a cargo platform 34 having a front edge 36 and a back edge 38. The cargo module arrangement 32 also includes a cargo gate 40 that is disposed proximate to the back edge 38 of the cargo platform 34. The cargo gate 40 includes a forward edge 42 and a rearward edge 44. In this embodiment, the rearward edge 44 of the cargo gate 40 coincides with the back edge 38 of the cargo platform 34. The vehicle 33 also includes a BIW portion 46, and a load floor 48 positioned below the cargo platform 34. The cargo gate 40 is pivotable upward about at least one of the forward edge 42 or the rearward edge 44. In this embodiment, the cargo gate 40 is slidable and pivotable—this is illustrated in FIG. 4A, which shows the cargo gate 40 after it has been slid rearward in a linear motion along a longitudinal vehicle axis toward a back of the vehicle 33. FIG. 4B shows the cargo gate 40 pivoted upward about a transverse vehicle axis coincident with the forward edge 42. Because the cargo gate 40 is slidable rearward prior to being pivoted upward, this configuration allows the full length of the cargo platform 34 to be used without interference from the cargo gate 40.

The cargo platform 34 and the cargo gate 40 are each shown as one piece in FIG. 3, but one or both of the cargo platform 34 and the cargo gate 40 could be formed as multiple pieces that are detachably connected together. For example, the cargo platform 34 and the cargo gate 40 could each be formed as two sections or halves split along a longitudinally extending dividing line, e.g., formed as right and left sections or halves, that are detachably connected together. Likewise, the cargo platform and/or cargo gate of any of the cargo-module arrangements disclosed herein could be formed as multiple pieces that are detachably connected together.

FIG. 4A identifies a detail 5 shown enlarged in FIG. 5, which illustrates a pivoting—sliding attachment mechanism 50 for the cargo gate 40. The attachment mechanism 50 includes an outer tube or sleeve 52 and an inner bar 54, which may or may not be a tubular structure. The sleeve 52 and the bar 54 are arranged with a sliding fit such that the bar 54 is slidable inside the sleeve 52 as indicated by the directional arrow 56. The attachment mechanism 50 also includes a rotatable connection 58 that divides the bar 54 into a front portion 60 and a rear portion 62, which allows the rear portion 62 to be pivoted upward relative to the front portion 60 as indicated by the directional arrow 64. This allows the cargo gate 42 to be pivoted upward about its forward edge 42 as shown in FIG. 4B.

Alternatively or supplementally, the attachment mechanism 50 may be configured to allow the cargo gate 40 to pivot upward about its rearward edge 44. For example, the rear portion 62 of the bar 54 may be pivotally connected to the cargo gate 40 proximate the rearward edge 44 so that the forward edge 42 of the cargo gate 40 may be pivoted upwardly about a horizontal, transverse vehicle axis that extends parallel to the rearward edge 44. Furthermore, an attachment mechanism 50 may be connected to the cargo gate 40 and the vehicle 33 on each lateral side of the cargo gate 40. For example, the sleeve 52 of each attachment mechanism 50 may be connected to the vehicle 33 on a respective lateral side of the cargo gate 40, and the rear portion 62 of the bar 54 of each attachment mechanism 50 may be connected to a respective lateral side of the cargo gate 40.

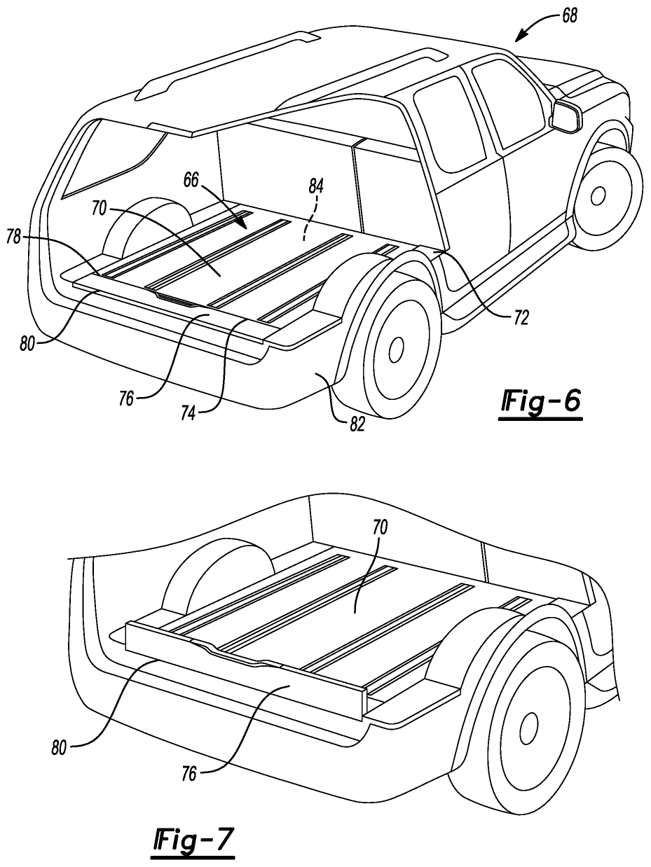

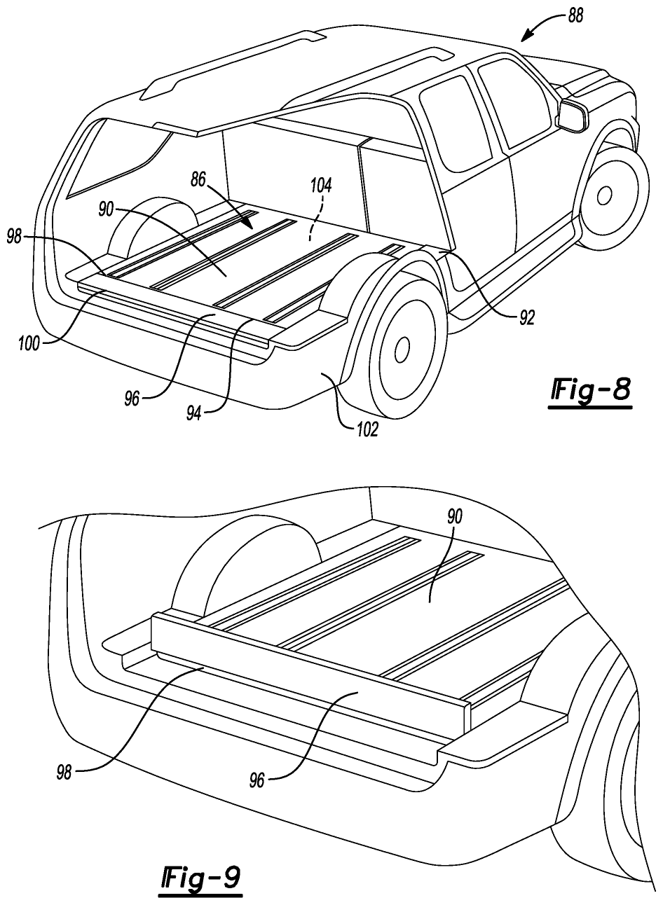

FIG. 6 shows a cargo-module arrangement 66 for a vehicle 68 in accordance with embodiments described herein. The cargo-module arrangement 66 includes a cargo platform 70 having a front edge 72 and a back edge 74. The cargo module arrangement 66 also includes a cargo gate 76 that is disposed proximate to the back edge 74 of the cargo platform 70. The cargo gate 76 includes a forward edge 78 and a rearward edge 80. In this embodiment, the rearward edge 80 of the cargo gate 76 is positioned rearward of the back edge 74 of the cargo platform 70. The vehicle 68 also includes a BIW portion 82, and a load floor 84 positioned below the cargo platform 70. In this embodiment, the cargo gate 76 is pivotable upward about its rearward edge 80, which is shown in FIG. 7.

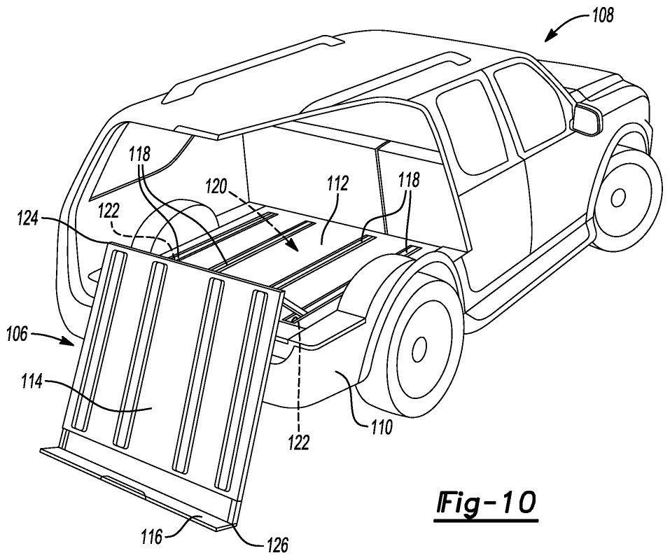

FIG. 8 shows a cargo-module arrangement 86 for a vehicle 88 in accordance with embodiments described herein. The cargo-module arrangement 86 includes a cargo platform 90 having a front edge 92 and a back edge 94. The cargo module arrangement 86 also includes a cargo gate 96 that is disposed proximate to the back edge 94 of the cargo platform 90. The cargo gate 96 includes a forward edge 98 and a rearward edge 100. The vehicle 88 also includes a BIW portion 102, and a load floor 104 positioned below the cargo platform 90. In this embodiment, the cargo gate 96 is pivotable upward about its forward edge 98, which is shown in FIG. 9.

FIG. 10 shows a cargo-module arrangement 106 for a vehicle 108 in accordance with embodiments described herein. Vehicle 108 includes a BIW portion 110 and a load floor 112 secured to the BIW portion 110. The cargo-module arrangement 106 includes a cargo platform 114 disposed above the load floor 112, and having a cargo gate 116. A plurality of slots 118 are disposed in the load floor 112 to facilitate forward and rearward movement of the cargo platform 114 relative to the load floor 112. Positioned below the load floor 112 is a track arrangement 120 that includes a plurality of tracks 122 attached to the BIW portion 110. As shown in FIG. 10, the cargo platform 114 is pivotably attached to the tracks 122 such that it can pivot relative to the load floor 112. In the embodiment shown in FIG. 10, the cargo platform 114 is attached to the tracks 122 proximate to its front edge 124. The cargo platform 114 also has a back edge 126 positioned proximate to the cargo gate 116.

As shown in FIG. 10, the cargo platform 114 is disposed at a rearward position along the tracks 122 and is positioned outside of the vehicle 108. The cargo platform 114 is tilted downward such that the cargo gate 116 is positioned below the load floor 112. In the embodiment shown in FIG. 10, and at least some of the previous embodiments described herein, the cargo platform 114 can be detached from the tracks 122 and removed from the vehicle 108. Because the tracks 122 are positioned below the load floor 112, they do not interfere with any cargo that may be loaded onto the load floor 112 when the cargo platform 114 is removed from the vehicle 108.

Furthermore, the cargo platform 114 may include one or more handles that can be grasped to facilitate moving or carrying the cargo platform 114 beyond the vehicle 108. For example, a handle (e.g., plastic handle or fabric strap) may be attached to or integrally formed with the cargo gate 116 at or near a rear edge of the cargo gate 116, and/or a handle may be provided on the cargo platform 114 at or near the front edge 124. Alternatively or supplementally, the cargo platform 114 may be provided with one or more rotatable members, e.g., rollers or wheels, to facilitate moving the cargo platform 114 on the ground when the cargo platform 114 is removed from the vehicle 108. For example, one or more rotatable members may be provided on a bottom of the cargo platform 114 proximate the back edge 126.

Embodiments described herein may include a cargo-module arrangement for a vehicle having a body-in-white (BIW) portion and a load floor secured to the BIW portion. The cargo-module arrangement may comprise a cargo platform disposed above the load floor and having a front edge and a back edge, the cargo platform being selectively movable along a track arrangement in forward and rearward directions and including a cargo gate disposed proximate to the back edge, and wherein the cargo gate includes a forward edge and a rearward edge and is pivotable upward about at least one of the forward edge or the rearward edge.

Embodiments described herein may include the cargo-module arrangement of Paragraph 0028, wherein the cargo gate is pivotable about the forward edge.

Embodiments described herein may include the cargo-module arrangement of Paragraph 0028, wherein the cargo gate is pivotable about the rearward edge.

Embodiments described herein may include the cargo-module arrangement of any of Paragraph 0028-0030, wherein the cargo gate is slidable and pivotable.

Embodiments described herein may include the cargo-module arrangement of any of Paragraphs 0028-0031, wherein the track arrangement includes a plurality of tracks attached to the BIW portion and positioned below the load floor.

Embodiments described herein may include the cargo-module arrangement of any of Paragraphs 0028-0032, wherein the cargo platform is removable from the vehicle.

Embodiments described herein may include the cargo-module arrangement of Paragraph 0032, wherein the cargo platform is pivotably attached to the tracks such that it can pivot relative to the load floor.

Embodiments described herein may include the cargo-module arrangement of Paragraph 0032 or Paragraph 0034, wherein the cargo platform is attached to the tracks proximate to the front edge of the cargo platform such that the back edge of the cargo platform can be tilted downward below the load floor when the cargo platform is disposed at a rearward position along the tracks.

Embodiments described herein may include a cargo-module arrangement for a vehicle having a body-in-white (BIW) portion and a load floor secured to the BIW portion. The cargo-module arrangement may comprise a cargo platform selectively movable along a track arrangement having tracks disposed below the load floor, the tracks being oriented in a longitudinal vehicle direction, and a cargo gate positioned toward a rear portion of the cargo platform and operable to be moved in at least one of a pivotable motion along a transverse vehicle axis or a linear motion along a longitudinal vehicle axis.

Embodiments described herein may include the cargo-module arrangement of Paragraph 0036, wherein the cargo platform is pivotable relative to the load floor.

Embodiments described herein may include the cargo-module arrangement of Paragraph 0036 or Paragraph 0037, wherein the cargo platform is tiltable downward such that the cargo gate is positioned below the load floor.

Embodiments described herein may include the cargo-module arrangement of any of Paragraphs 0036-0038, wherein the tracks are attached to the BIW portion of the vehicle.

Embodiments described herein may include the cargo-module arrangement of any of Paragraphs 0036-0039, wherein the cargo gate is slidable and pivotable relative to the cargo platform.

Embodiments described herein may include the cargo-module arrangement of any of Paragraphs 0036-0040, wherein the cargo platform includes a front edge and a back edge, and the cargo platform is attached to the tracks proximate to the front edge such that the back edge can be tilted downward below the load floor when the cargo platform is disposed at a rearward position along the tracks.

Embodiments described herein may include the cargo-module arrangement of any of Paragraphs 0036-0041, wherein the cargo gate includes a forward edge and a rearward edge, and the cargo gate is pivotable about at least one of the forward edge or the rearward edge.

Embodiments described herein may include a cargo-module arrangement for a vehicle having a body-in-white (BIW) portion and a load floor secured to the BIW portion. The cargo-module arrangement may comprise a cargo platform disposed above the load floor and having a front edge and a back edge, the cargo platform being selectively movable in forward and rearward directions relative to the load floor and including a cargo gate disposed proximate to the back edge, and wherein the cargo gate includes a forward edge and a rearward edge and is pivotable upward about at least one of the forward edge or the rearward edge.

Embodiments described herein may include the cargo-module arrangement of Paragraph 0043, wherein the cargo gate is slidable and pivotable.

Embodiments described herein may include the cargo-module arrangement of Paragraph 0043 or Paragraph 0044, further comprising a track arrangement having tracks disposed below the load floor and oriented along a longitudinal vehicle axis, and wherein the cargo platform is selectively movable along the tracks.

Embodiments described herein may include the cargo-module arrangement of Paragraph 0045, wherein the cargo platform includes a front edge and a back edge, and the cargo platform is attached to the tracks proximate to the front edge such that the back edge can be tilted downward below the load floor when the cargo platform is disposed at a rearward position along the tracks.

Embodiments described herein may include the cargo-module arrangement of Paragraph 0045 or Paragraph 0046, wherein the tracks are attached to the BIW portion and the cargo platform is positioned above the load floor.

While exemplary embodiments are described above, it is not intended that these embodiments describe all possible forms according to the disclosure. In that regard, the words used in the specification are words of description rather than limitation, and it is understood that various changes may be made without departing from the spirit and scope of the disclosure. Additionally, the features of various implementing embodiments may be combined to form further embodiments according to the disclosure.

What is claimed is:

1. A cargo-module arrangement for a vehicle having a body-in-white (BIW) portion and a load floor secured to the BIW portion, the cargo-module arrangement comprising:
a cargo platform disposed above the load floor and having a front edge and a back edge, the cargo platform being selectively movable along a track arrangement in forward and rearward directions and including a cargo gate disposed proximate to the back edge, and wherein the cargo gate includes a forward edge and a rearward edge and is pivotable upward about at least one of the forward edge or the rearward edge.

2. The cargo-module arrangement of claim 1, wherein the cargo gate is pivotable about the forward edge.

3. The cargo-module arrangement of claim 1, wherein the cargo gate is pivotable about the rearward edge.

4. The cargo-module arrangement of claim 3, wherein the cargo gate is slidable and pivotable.

5. The cargo-module arrangement of claim 1, wherein the track arrangement includes a plurality of tracks attached to the BIW portion and positioned below the load floor.

6. The cargo-module arrangement of claim 5, wherein the cargo platform is removable from the vehicle.

7. The cargo-module arrangement of claim 5, wherein the cargo platform is pivotably attached to the tracks such that it can pivot relative to the load floor.

8. The cargo-module arrangement of claim 7, wherein the cargo platform is attached to the tracks proximate to the front edge of the cargo platform such that the back edge of the cargo platform can be tilted downward below the load floor when the cargo platform is disposed at a rearward position along the tracks.

9. A cargo-module arrangement for a vehicle having a body-in-white (BIW) portion and a load floor secured to the BIW portion, the cargo-module arrangement comprising:
a cargo platform selectively movable along a track arrangement having tracks disposed below the load floor, the tracks being oriented in a longitudinal vehicle direction; and
a cargo gate positioned toward a rear portion of the cargo platform and operable to be moved in at least one of a pivotable motion along a transverse vehicle axis or a linear motion along a longitudinal vehicle axis.

10. The cargo-module arrangement of claim 9, wherein the cargo platform is pivotable relative to the load floor.

11. The cargo-module arrangement of claim 9, wherein the cargo platform is tiltable downward such that the cargo gate is positioned below the load floor.

12. The cargo-module arrangement of claim 9, wherein the tracks are attached to the BIW portion of the vehicle.

13. The cargo-module arrangement of claim 9, wherein the cargo gate is slidable and pivotable relative to the cargo platform.

14. The cargo-module arrangement of claim 9, wherein the cargo platform includes a front edge and a back edge, and the cargo platform is attached to the tracks proximate to the front edge such that the back edge can be tilted downward below the load floor when the cargo platform is disposed at a rearward position along the tracks.

15. The cargo-module arrangement of claim 9, wherein the cargo gate includes a forward edge and a rearward edge, and the cargo gate is pivotable about at least one of the forward edge or the rearward edge.

16. A cargo-module arrangement for a vehicle having a body-in-white (BIW) portion and a load floor secured to the BIW portion, the cargo-module arrangement comprising:
a cargo platform disposed above the load floor and having a front edge and a back edge, the cargo platform being selectively movable in forward and rearward directions relative to the load floor and including a cargo gate disposed proximate to the back edge, and wherein the cargo gate includes a forward edge and a rearward edge and is pivotable upward about at least one of the forward edge or the rearward edge.

17. The cargo-module arrangement of claim 16, wherein the cargo gate is slidable and pivotable.

18. The cargo-module arrangement of claim 16, further comprising a track arrangement having tracks disposed below the load floor and oriented along a longitudinal vehicle axis, and wherein the cargo platform is selectively movable along the tracks.

19. The cargo-module arrangement of claim 18, wherein the cargo platform includes a front edge and a back edge, and the cargo platform is attached to the tracks proximate to the front edge such that the back edge can be tilted downward below the load floor when the cargo platform is disposed at a rearward position along the tracks.

20. The cargo-module arrangement of claim 19, wherein the tracks are attached to the BIW portion and the cargo platform is positioned above the load floor.
